(19) United States
(12) Patent Application Publication
(10) Pub. No.: US 2026/0235232 A1
(43) Pub. Date: Aug. 13, 2026

(54) COMPOSITE PIPE

(71) Applicant: MAGMA GLOBAL LIMITED, Portsmouth, Hampshire (GB)

(72) Inventors: Daniel HOLMAN, Southampton (GB); Josh RICHARDSON, Fareham (GB); Thomas EPSZTEIN, Rouen (FR)

(21) Appl. No.: 19/151,485

(22) PCT Filed: Feb. 5, 2024
(86) PCT No.: PCT/GB2024/050303

§ 371 Date: Jul. 28, 2025

(30) Foreign Application Priority Data
Feb. 6, 2023 (GB) 2301644.7

(51) Int. Cl. F16L 11/04; B32B 1/08; B32B 27/18; F16L 35/00

(52) U.S. Cl. CPC F16L 11/04; B32B 1/08; B32B 27/18; F16L 35/00; B32B 2262/16; B32B 2307/54; B32B 2597/00

(57) ABSTRACT

A composite pipe which extends longitudinally and has an internal surface and an external surface, a composite overlay being disposed around and bonded to a portion of the external surface, the composite pipe and the composite overlay including a composite material having a thermoplastic polymer matrix and fibres embedded in the thermoplastic polymer matrix, the embedded fibres in the thermoplastic polymer matrix of the composite pipe include continuous fibres, and embedded fibres embedded in the thermoplastic polymer matrix of the composite overlay include short fibres, which are fibres having a length from 0.05 mm to 10 mm.

### FIELD OF THE INVENTION

The invention relates to a composite pipe; to an unbonded, flexible pipe, comprising the composite pipe; to the use of the composite pipe or of the unbonded, flexible pipe for transporting hydrocarbon fluid, hydrogen fluid, carbon dioxide fluid, or mixtures thereof; and to a method of manufacturing the composite pipe.

### DESCRIPTION OF THE RELATED ART

Subsea oil and gas drilling and development employs pipes to transport liquid and/or gaseous hydrocarbons from the seabed to the sea surface and to transport injection fluids from the surface to the seabed. These pipes have typically been made from a steel pipe associated with additional unbonded layers, such as one or more layer(s) of steel armour wires encased in a plastic sheath. Such unbonded, flexible, steel pipes are covered by American Petroleum Institute standard API 17J.

Over time, the subsea depths at which hydrocarbons are extracted has tended to increase. This development has been accompanied by a need to operate under harsher conditions including one or more of conditions of increased salinity, higher acidity, higher internal and external pressures, and higher temperatures. In order to address these challenges, the industry has turned to composite pipes, comprising fibre-reinforced thermoplastic polymer. Reference may be made to WO 2012/072993 A1 which discloses such composite pipes. These pipes may be manufactured by winding tapes of composite material onto a pipe liner and fusing them thereto, then winding further layers of tape on top and fusing each layer to the immediately preceding layer. The composite material typically comprises a thermoplastic matrix, such as polyether ether ketone, within which continuous fibres are embedded, the continuous fibres are typically carbon or glass fibres and the liner is typically made of the same thermoplastic material as the matrix. These pipes are lighter and better able to withstand the more severe environments as well as the more complex dynamic loading conditions including tension, torsion, bending and internal/external pressure found deep below the sea surface. DNV standard DNVGL-ST-F119 (August 2018) relates to thermoplastic composite pipes for offshore applications in the oil and gas industry.

More recently, unbonded, flexible, composite pipes have also been developed. In similar fashion to unbonded, flexible steel pipes, these pipes may comprise a composite pipe associated with additional unbonded layers, such as one or more layer(s) of steel armour wires. Reference may be made to WO 2019/068757 A1.

An obstacle to the introduction of composite pipes has been the ability to effectively terminate such pipes and to reliably connect them to non-composite, especially steel, piping and apparatus at both subsea and surface interfaces. Composite pipe terminations and connections must be able to provide a reliable transition from the composite pipe material to a standard steel pipe, which may typically incorporate a steel flange or hub connection. The different structural properties of the two materials on the one hand and the differences in thermal expansion on the other, may make it challenging to effect both a reliable structural and sealing connection. Reference may also be made to WO 2017/163021 A1, which discloses end-fittings for a composite pipe.

End-fittings of both composite pipes and unbonded, flexible composite pipes may comprise a built-up portion or overlay at or near to the composite pipe end. Such a built-up portion may facilitate the attachment of steel fittings for connection of the composite pipe to steel piping. As disclosed in WO 2017/163021 A1, the built-up portion may comprise the same material as the composite pipe, that is a composite material comprising continuous fibres embedded in a thermoplastic polymer matrix. A built-up portion of composite material comprising continuous fibres may be challenging to machine in order to provide a shape that interfaces in a desired way with other components, such as a metal vault. Machine tools may break and uproot the continuous fibres in the composite, initiating cracks in the matrix which may then propagate further when a structure is stressed in use in high pressure and high temperature environments. Moreover, if the continuous fibres are electrically conductive, such as carbon fibre, then they may establish an electrical connection between metal components and the composite pipe, which may, in turn, facilitate corrosion of the metal components.

Alternatively, the built-up portion may consist of thermoplastic polymer (without embedded fibres), as disclosed in WO 2019/068757 A1. In such a case, the thermoplastic polymer may be the same thermoplastic polymer as that used in the matrix of the composite pipe, which may facilitate a strong attachment at the interface between the built-up portion and the composite pipe. Doing so avoids the presence of protruding fibres rendering the built-up portion easy to machine. Since the thermoplastic polymer is an electrical insulator, it may serve to insulate metallic components from the composite pipe, reducing the corrosion risk. On the other hand, the coefficient of thermal expansion (CTE) of thermoplastic polymer alone may be significantly different from the CTE of the underlying composite pipe. If the arrangement is subjected to high temperatures, which are not uncommon in hydrocarbon extraction, then the differential in thermal expansion between the composite pipe and the built-up portion may give rise to significant stresses and potentially also to cracking and failure of the built-up portion.

It is against this background that the present invention has been devised.

### SUMMARY OF THE INVENTION

According to a first aspect of the invention, a composite pipe is provided which extends longitudinally and has an internal surface and an external surface, a composite overlay being disposed around and bonded to a portion of the external surface, wherein the composite pipe and the composite overlay comprise a composite material having a thermoplastic polymer matrix and fibres embedded in the thermoplastic polymer matrix, wherein the fibres embedded in the thermoplastic polymer matrix of the composite pipe comprise continuous fibres, and wherein the fibres embedded in the thermoplastic polymer matrix of the composite overlay comprise short fibres, which are fibres having a length from 0.05 mm to 10 mm.

Short fibre composites behave like unfilled thermoplastic polymer plastics and, when machined, do not suffer from the disadvantages of composites comprising embedded, continuous fibres. Moreover, a composite overlay comprising short fibres tends to have a coefficient of thermal expansion which is closer to that of the material of the composite pipe, eliminating or significantly reducing the likelihood of cracking and failure associated with thermal stresses which arise during manufacture and as a result of substantial variations of temperature which may arise in use. Lastly, if appropriately distributed within the thermoplastic polymer matrix, short fibres of the present type may have an electrical conductivity which is the same as, or not materially different from, the thermoplastic matrix alone, thereby militating against the formation of an electrical connection between metal components and the composite pipe.

According to one example of the first aspect of the invention, the fibres embedded in the thermoplastic polymer matrix of the composite overlay comprise at least 80% short fibres. According to another example, the fibres embedded in the thermoplastic polymer matrix of the composite overlay consist of short fibres, so that the only fibres present in the composite overlay are short fibres.

According to one example of the first aspect of the invention, the short fibres have a length from 0.05 mm to 5.0 mm. According to another example, the short fibres have a length from 0.1 mm to 4.0 mm.

According to one example of the first aspect of the invention, the ratio of the fibre length to its diameter is in the range 5 to 1000. According to another example, the ratio of the fibre length to its diameter is in the range 10 to 400.

According to one example of the first aspect of the invention, the composite overlay comprises less than 60% by weight of fibres. According to another example, the composite overlay comprises from 5% to 40% by weight of fibres. According to a further example, the composite overlay comprises from 10% to 30% by weight of fibres.

According to one example of the first aspect of the invention, the composite pipe may comprise a composite overlay which is anistropic. Anisotropy may provide the composite overlay with one or more enhanced properties in a particular direction in which those properties are important. Anisotropy may be achieved by preferentially aligning the short fibres in a particular direction and such preferential alignment may be achieved via an extrusion process. In one example, the short fibres may be preferentially aligned in the circumferential (hoop) direction versus the longitudinal direction (the direction of the composite pipe's axis). Anisotropy may be shown via different parameters, such as the Young's (or Tensile) Modulus or coefficient of thermal expansion in the circumferential (hoop) direction versus the longitudinal direction (the direction of the pipe axis).

According to one example, the composite overlay comprises a sufficient proportion of circumferentially aligned fibres for the Young's Modulus of the composite overlay to be greater in the circumferential direction than in the longitudinal direction. According to another example, the Young's Modulus of the composite overlay is from 110% to 1000% greater in the circumferential direction than in the longitudinal direction. Young's (Tensile) Modulus is measured according to the standard ISO 527-1 (General Principles) and ISO 527-2 and the test conditions were as follows:
Sample geometry as per ISO 527-2 type 1BA;
Thickness: between 3 and 4 mm
Speed of testing: 1 mm/min
Calculation of modulus: Chord 0.1% to 0.3% strain (see formulae in ISO 527-1, § 10.3.2)
Ambient conditions for preconditioning and testing: 23° C.; 50% relative humidity.

According to one example of the first aspect of the invention, the fibres embedded in the thermoplastic polymer matrix of the composite pipe comprise at least 80% continuous fibres. According to another example the fibres embedded in the thermoplastic polymer matrix of the composite pipe consist of continuous fibres, so that the only fibres present in the thermoplastic polymer matrix of the composite pipe are continuous fibres.

According to one example of the first aspect of the invention, the composite pipe and the composite overlay comprise or consist of the same thermoplastic polymer matrix. For the present purposes, two different grades of a thermoplastic polymer, which differ from one another only by virtue of having different molecular weights, are considered to be “the same”. Using the same thermoplastic polymer may allow a strong bond between the composite pipe and the composite overlay. According to another example, the composite pipe comprises or consists of a different thermoplastic polymer matrix from the composite overlay.

According to one example of the first aspect of the invention, the thermoplastic polymer matrix of the composite pipe comprises or consists of a polymer selected from polyether ether ketone (PEEK), polyetherketoneketone (PEKK), polyetherketone (PEK), polyetherketoneetherketoneketone (PEKEKK), Polyetheretherketoneketone (PEEKK), Polyphenylene sulfide (PPS), Polyvinylidene fluoride (PVDF), polyamide 11 (PA11), Polyvinylidene fluoride-co-hexafluoropropylene (PVDF-HFP), polyamide 12 (PA12), polyethylene, polypropylene, or mixtures thereof. According to another example, the thermoplastic polymer matrix of the composite pipe consists of PEEK.

According to one example of the first aspect of the invention, the thermoplastic polymer matrix of the composite overlay comprises or consists of a polymer selected from polyether ether ketone (PEEK), polyetherketoneketone (PEKK), polyetherketone (PEK), polyetherketoneetherketoneketone (PEKEKK), Polyetheretherketoneketone (PEEKK), Polyphenylene sulfide (PPS), Polyvinylidene fluoride (PVDF), polyamide 11 (PA11), Polyvinylidene fluoride-co-hexafluoropropylene (PVDF-HFP), polyamide 12 (PA12), polyethylene, polypropylene, or mixtures thereof. According to another example, the thermoplastic polymer matrix of the composite overlay consists of PEEK.

According to one example of the first aspect of the invention, the fibres embedded in the thermoplastic polymer matrix of the composite pipe comprise or consist of a material selected from carbon, aramid, basalt, glass and mixtures thereof. According to another example, the fibres embedded in the thermoplastic polymer matrix of the composite pipe consist of carbon fibres.

According to one example of the first aspect of the invention, the fibres embedded in the thermoplastic polymer matrix of the composite overlay comprise or consist of a material selected from carbon, aramid, basalt, glass and mixtures thereof. According to another example, the fibres embedded in the thermoplastic polymer matrix of the composite overlay consist of carbon fibres.

According to one example of the first aspect of the invention, the fibres embedded in the thermoplastic polymer matrix of the composite pipe comprise or consist of the same material as the fibres embedded in the thermoplastic polymer of the composite overlay. According to another example, the fibres embedded in the thermoplastic polymer matrix of the composite pipe are made from a different material than the fibres embedded in the thermoplastic polymer of the composite overlay.

According to one example of the first aspect of the invention, if short fibres embedded in the thermoplastic polymer matrix of the composite overlay are electrically conductive, such as carbon fibres, then they are distributed throughout the thermoplastic matrix such that the composite overlay has a volume resistivity of greater than 10² ohm·m, preferably greater than 10⁴ ohm·m.

The volume resistivity was measured according to the standard IEC 62631-3-1. The definition of volume resistivity is as per § 3.2 and the calculation as per § 6.3 and the test conditions were as follows:
Voltage 100V
Electrodes: conductive silver paint
Specimen dimensions: 50 mm×50 mm×1 mm
Number of test specimens: 3.
The volume resistance was be determined after a fixed time of electrification of 1 min.
Ambient condition for preconditioning and testing: 23° C.; 50% relative humidity.

According to one example of the first aspect of the invention, the thermoplastic polymer matrix of the composite pipe and the thermoplastic polymer matrix of the composite overlay consist of PEEK and the fibres embedded in the thermoplastic polymer matrix of the composite pipe and the fibres embedded in the thermoplastic polymer matrix of the composite overlay are carbon fibres.

According to one example of the first aspect of the invention, a liner may be attached to the internal surface of the composite pipe. The liner may typically be made of thermoplastic polymer. In one example, the liner may comprise or consist of the same thermoplastic polymer as is used for the thermoplastic polymer matrix of the composite pipe. For the present purposes, two different grades of a thermoplastic polymer, which differ from one another only by virtue of having different molecular weights, are considered to be “the same”. In another example, the liner may comprise or consist of a different thermoplastic polymer from that used for the thermoplastic polymer matrix of the composite pipe.

According to one example of the first aspect of the invention, the portion of the external surface to which the thermoplastic overlay is bonded extends longitudinally along the composite pipe away from the pipe end. According to this example, the composite overlay may also extend longitudinally beyond the pipe end. Furthermore, according to this example, the composite pipe may additionally comprise an end-fitting, wherein the end-fitting comprises a metal, suitably steel, vault disposed around the composite overlay, the metal vault comprising (i) means to lock the metal vault into mating engagement with the composite overlay and (ii) means for sealingly attaching a connector into to the pipe end.

According to a second aspect of the invention, an unbonded, flexible pipe is provided, comprising the composite pipe of the first aspect of the invention and one or more unbonded armour layers, wherein armour layer(s) are disposed around the external surface of the composite pipe and/or wherein armour layer(s) are disposed within the composite pipe. In one example, the armour layers are tensile armour layers as defined in the 4^{th} Edition of API17J and are made of carbon steel, stainless steel, thermoplastic composite material, or thermoset composite material. In another example, armour layer(s) are pressure armour layer as defined in the 4th Edition of API17J and are made of carbon steel, stainless steel, thermoplastic composite material, or thermoset composite material. In another example, an armour layer may be a carcass layer as defined in the 4^{th} Edition of API17J and are made of stainless steel or carbon steel.

According to a third aspect of the invention, the use is provided of the composite pipe of the first aspect of the invention, or of an unbonded, flexible pipe of the second aspect of the invention, for transporting hydrocarbon fluid, hydrogen fluid or carbon dioxide fluid, or a mixture thereof. The hydrocarbon fluid, hydrogen fluid or carbon dioxide fluid may be in liquid or gaseous form or a mixture thereof. For example, it may comprise crude oil, natural gas or mixtures thereof. Moreover, the composite pipe of the first aspect of the invention and the unbonded, flexible pipe of the second aspect of the invention, may be used for transporting for transporting any fluid at high temperature and/or high pressure.

According to a fourth aspect of the invention, a method is provided of manufacturing a composite pipe which extends longitudinally and has an internal surface and an external surface, a composite overlay being disposed around and bonded to a portion of the external surface, the method comprising:
a. providing a composite pipe;
b. winding a first layer of composite tape around and bonding it to the portion of the external surface; and
c. winding one or more additional layers of composite tape around and bonding each such additional layer to the immediately preceding layer of composite tape until a desired overlay thickness has been achieved;
wherein the composite pipe and the composite tape comprise a composite material having a thermoplastic polymer matrix and fibres embedded in the thermoplastic polymer matrix, wherein the fibres embedded in the thermoplastic polymer matrix of the composite pipe comprise continuous fibres, and wherein the fibres embedded in the thermoplastic polymer matrix of the composite tape comprise short fibres, which are fibres having a length from 0.1 mm to 10 mm.

In one example of the method of the fourth aspect of the invention, each layer of composite tape is wound at the same angle as the other layers. According to this example, the layers are wound at an angle in the range from ≥+80° to ≤−80°, or ≥+85° to ≤−85° where the longitudinal axis of the composite pipe is 0°.

In another example of the method of the fourth aspect of the invention, after a. and before b.:
a1. the portion of the external surface is machined to reduce its external diameter.

Machining may be achieved by methods known to the skilled person, such as by grinding. In one example, machining the surface may also be performed to achieve one or more of increasing or reducing the smoothness of the external surface. In another example, machining the surface may be performed in a non-uniform way to change the shape or the external surface, for example to render it more oval in shape.

In one example of the fourth aspect of the invention, the windings of composite tape are bonded to the underlying surface, be it the pipe itself in the case of b., or the underlying layer of composite tape, in the case of c., by heating and fusing them together. Such heating may be performed to one or both of the contact surfaces immediately prior to contact between the surfaces, in a manner known to the skilled person. Where possible, only a thin layer of any surface is heated. More extensive heating is unnecessary and wasteful of energy. Moreover, it may also be disadvantageous, because softening or melting a thermoplastic polymer may result in altered crystallinity during cooling, which in turn may affect properties, such the tape's fracture toughness. A laser may provide a suitable method for such thin-layer heating, softening and melting and, in one example, the tapes are laser-welded to the pipe and to one another.

In one example of the fourth aspect of the invention, the portion of the external surface around which the first layer of composite tape is wound and to which it is bonded extends longitudinally along the composite pipe away from the pipe end.

After application of the layers of composite tape, the composite overlay may be machined to provide it with an appropriate shape and/or appropriately formed surfaces which interface in a desired way with other components. Machining may be achieved by methods known to the skilled person, such as by grinding.

### BRIEF DESCRIPTION OF THE DRAWINGS

The invention will now be further described, by way of example only, and with reference to the accompanying drawings, in which:

FIG. 1 shows a side view of an exemplary composite pipe.

FIG. 2 shows a side view of an exemplary unbonded, flexible pipe.

FIG. 3 is a microscope image of a slice through an exemplary composite overlay using an Olympus BX51M camera with a ×100 magnification.

### DETAILED DESCRIPTION

A detailed description of the invention will now be provided with reference to the above figures. A given reference number is always used to denote the same feature in each of the accompanying drawings.

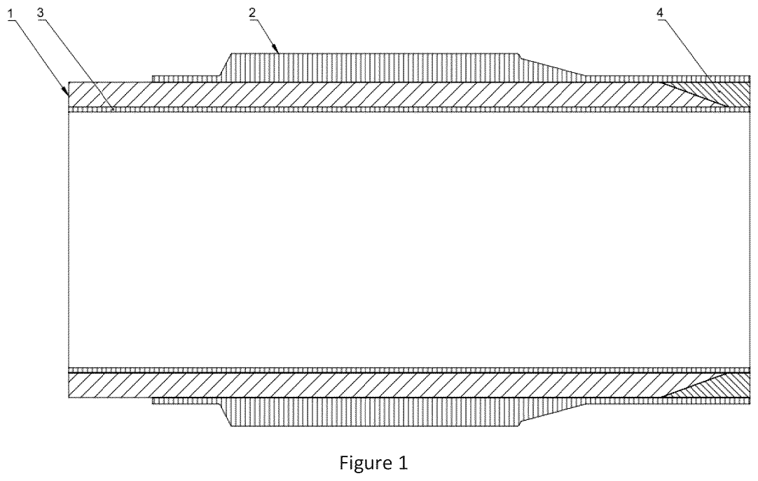

With reference to FIG. 1, a 5.08 cm (2 inch) inside diameter (80 mm outside diameter) composite pipe (1) was provided, the pipe being made of a composite material comprising continuous carbon fibres embedded in a PEEK matrix and was made from composite tapes wound at a 55-degree angle to the pipe axis. The composite pipe (1) was formed around a liner (3) made of PEEK.

The composite pipe (1) was provided with a 22 mm thickness composite overlay (2) extending from and away from the pipe end for 500 mm along the pipe. The composite overlay (2) also extended beyond the pipe end and some infill (4) was provided at the pipe end.

The composite overlay (2) was manufactured by winding a layer of composite tape around the composite pipe (1) at a winding angle of close to 90° (where the longitudinal axis of the composite pipe is) 0° and fusing it thereto, then winding additional layers of composite tape at a winding angle of close to 90° over the first layer and fusing each additional layer of composite tape to the immediately preceding layer until a desired initial thickness was achieved. The composite overlay (2) was then machined to reduce the thickness to 22 mm and provide surfaces for interaction with fittings, such as pipe end-fittings.

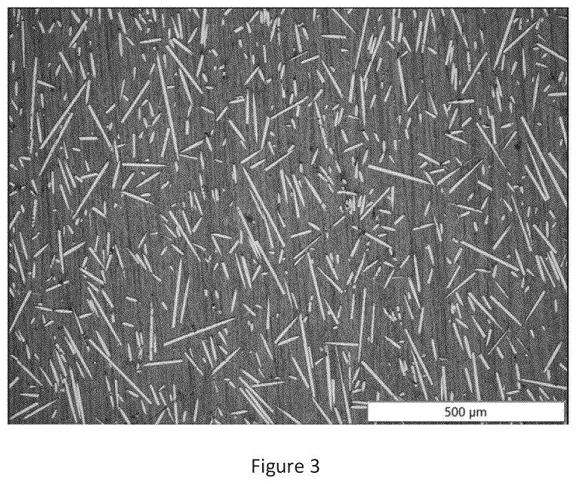

The composite tape used had a width of 12 mm and was made of a composite material comprising 20 wt % short carbon fibres having a mean length of 0.2 mm and a mean diameter of 7 μm embedded in a PEEK matrix. The alignment of the short carbon fibres was greater axially along the tapes than orthogonally thereto across the tape width. Since the tapes were wound at close to 90 degrees to the longitudinal axis of the composite pipe (1), this resulted in the composite overlay (2) having a greater fibre alignment in the circumferential (hoop) direction than in the longitudinal direction (the direction of the composite pipe axis). FIG. 3 shows a microscope image of a slice through the composite overlay in which the circumferential (hoop) direction is aligned top-to-bottom. The greater alignment of the short fibres top-to-bottom can be seen.

As can be seed from Table 1, inclusion of short fibres having a greater degree of alignment axially within the tapes bestowed anisotropy to the composite overlay in that the axially aligned short fibres provided the overlay with a higher Young's Modulus, break tensile strength in the circumferential (hoop) direction than in the longitudinal (axial) direction. Anisotropy is also demonstrated in the lower CTE value circumferentially versus in the longitudinal direction along the pipe axis.

TABLE 1

| | Pure | PEEK/Embedded |
|---|---|---|
| | PEEK | Short Fibre |
| Property | Overlay | Composite Overlay |
| Young's Modulus | 3.7 | 6.0 |
| in the longitudinal | | |
| (axial) direction (GPa) | | |
| Young's Modulus | 3.7 | 15 |
| in the circumferential | | |
| (hoop) direction (GPa) | | |
| Break Tensile Strength | 88 | 117 |
| in the longitudinal | | |
| (axial) direction (MPa) | | |
| Break Tensile Strength | 91 | 207 |
| in the circumferential | | |
| (hoop) direction (MPa) | | |
| Coefficient of | 65 | 45 |
| thermal expansion (CTE) | | |
| in the longitudinal | | |
| (axial) direction (10⁻⁶/° C.) | | |
| measured below the glass | | |
| transition temperature (Tg) | | |
| CTE in the circumferential | 45 | 8 |
| (hoop) direction (10⁻⁶/° C.) | | |
| measured below Tg | | |
| Coefficient of | 160 | 110 |
| thermal expansion (CTE) | | |
| in the longitudinal | | |
| (axial) direction (10⁻⁶/° C.) | | |
| measured above Tg | | |
| CTE in the circumferential | 125 | 8 |
| (hoop) direction (10⁻⁶/° C.) | | |
| measured above Tg | | |

Onset of Tg occurs at 143° C. and the midpoint of Tg occurs at 150° C., measured according to ISO 11357; CTE values were measured according to ISO 11359.

For comparison, the material of the composite pipe had a coefficient of thermal expansion (CTE) in the hoop direction of 4×10⁻⁶/° C. and 17.8×10⁻⁶/° C., measured in the direction of the composite pipe's axis. The CTE of the composite pipe in the hoop direction (4×10⁻⁶/° C.) was therefore significantly closer to the CTE of the composite overlay in the hoop direction (8×10⁻⁶/° C.), measured both below and above Tg, than to the CTE of pure PEEK (45×10⁻⁶/° C. below Tg and 125×10⁻⁶/° C. above Tg). The closer matching of the CTE-values reduces the likelihood of cracking and failure associated with thermal stress.

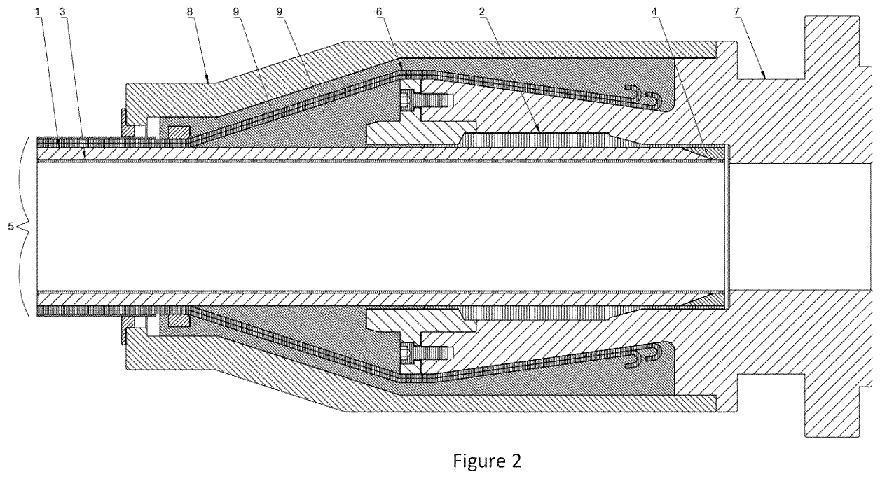

FIG. 2 shows a side view of an exemplary unbonded, flexible pipe (5) comprising a composite pipe (1), a liner (3) and a composite overlay (2) bonded to and extending longitudinally along the composite pipe (1) away from the pipe end. The flexible, unbonded pipe (5) comprises armour wires (6) disposed around the composite pipe (1). A steel end-fitting (7) comprising a flange is fitted around the composite overlay (2) and is attached to a steel vault (8) which also extends longitudinally along the composite pipe (1). Towards the pipe end, the armour wires (6) are displaced radially away from the composite pipe (1) and are potted in an epoxy filler (9) in the cavities enclosed by the steel vault. This arrangement provides an effective way to terminate the flexible, unbonded pipe (5) with a steel end-fitting (7).

The invention is not limited by the precise values given in this example. For example, a composite overlay may also be applied to a composite pipe having an external diameter of 76.2 mm (3 inches), 152.4 mm (6 inches) or other diameter and the tape used may have a different width, such as 18 mm.

1. A composite pipe which extends longitudinally and has an internal surface and an external surface, a composite overlay being disposed around and bonded to a portion of the external surface, wherein the composite pipe and the composite overlay comprise a composite material having a thermoplastic polymer matrix and fibres embedded in the thermoplastic polymer matrix, wherein the fibres embedded in the thermoplastic polymer matrix of the composite pipe comprise continuous fibres, and wherein the fibres embedded in the thermoplastic polymer matrix of the composite overlay comprise short fibres, which are fibres having a length from 0.05 mm to 10 mm.

2. The composite pipe according to claim 1, wherein the fibres embedded in the thermoplastic polymer matrix of the composite overlay comprise at least 80% short fibres.

3. The composite pipe according to claim 1, wherein the fibres embedded in the thermoplastic polymer matrix of the composite overlay consist of short fibres.

4. The composite pipe according to claim 1, wherein the short fibres have a length from 0.05 mm to 5.0 mm.

5. The composite pipe according to claim 1, wherein the short fibres have a length from 0.1 mm to 4.0 mm.

6. The composite pipe according to claim 1, wherein the ratio of the fibre length to its diameter is in the range 5 to 1000.

7. The composite pipe according to claim 1, wherein the ratio of the fibre length to its diameter is in the range 10 to 400.

8. The composite pipe according to claim 1, wherein the composite overlay comprises less than 60% by weight of fibres.

9. The composite pipe according to claim 1, wherein the composite overlay comprises from 5% to 40% by weight of fibres.

10. The composite pipe according to claim 1, wherein the composite overlay comprises from 10% to 30% by weight of fibres.

11. The composite pipe according to claim 1, wherein the composite overlay comprises a sufficient proportion of circumferentially aligned fibres for the Young's Modulus of the composite overlay to be greater in the circumferential direction than in the longitudinal direction.

12. The composite pipe of claim 11, wherein Young's Modulus of the composite overlay is from 110% to 1000% greater in the circumferential direction than in the longitudinal direction.

13. The composite pipe according to claim 1, wherein the fibres embedded in the thermoplastic polymer matrix of the composite pipe comprise at least 80% continuous fibres.

14. The composite pipe according to claim 1, wherein the fibres embedded in the thermoplastic polymer matrix of the composite pipe consist of continuous fibres.

15. The composite pipe according to claim 1, wherein the composite pipe and the composite overlay comprise the same thermoplastic polymer matrix, or wherein the composite pipe comprises a different thermoplastic polymer matrix from the composite overlay.

16. The composite pipe according to claim 1, wherein the thermoplastic polymer matrix of the composite pipe comprises a polymer selected from polyether ether ketone (PEEK), polyetherketoneketone (PEKK), polyetherketone (PEK), polyetherketoneetherketoneketone (PEKEKK), Polyetheretherketoneketone (PEEKK), Polyphenylene sulfide (PPS), Polyvinylidene fluoride (PVDF), Polyvinylidene fluoride-co-hexafluoropropylene (PVDF-HFP), polyamide 11 (PA11), polyamide 12 (PA12), polyethylene, polypropylene, or mixtures thereof.

17. The composite pipe according to claim 1, wherein the thermoplastic polymer matrix of the composite overlay comprises a polymer selected from polyether ether ketone (PEEK), polyetherketoneketone (PEKK), polyetherketone (PEK), polyetherketoneetherketoneketone (PEKEKK), Polyetheretherketoneketone (PEEKK), Polyphenylene sulfide (PPS), Polyvinylidene fluoride (PVDF), Polyvinylidene fluoride-co-hexafluoropropylene (PVDF-HFP), polyamide 11 (PA11), polyamide 12 (PA12), polyethylene, polypropylene, or mixtures thereof.

18. The composite pipe according to claim 1, wherein the fibres embedded in the thermoplastic polymer matrix of the composite pipe are made from a material selected from carbon, aramid, basalt, glass and mixtures thereof.

19. The composite pipe according to claim 1, wherein the fibres embedded in the thermoplastic polymer matrix of the composite overlay comprise a material selected from carbon, aramid, basalt, glass and mixtures thereof.

20. The composite pipe according to claim 1, wherein the fibres embedded in the thermoplastic polymer matrix of the composite pipe comprise the same material as, or from a different material than, the fibres embedded in the thermoplastic polymer of the composite overlay.

21. The composite pipe according to claim 1, wherein, if the short fibres embedded in the thermoplastic polymer matrix of the composite overlay are electrically conductive, then they are distributed throughout the thermoplastic matrix such that the composite overlay has a volume resistivity of greater than 10² ohm·m.

22. The composite pipe according to claim 1, wherein the wherein the thermoplastic polymer matrix of the composite pipe and the thermoplastic polymer matrix of the composite overlay consist of PEEK and wherein the fibres embedded in the thermoplastic polymer matrix of the composite pipe and the composite overlay are carbon fibres.

23. The composite pipe according to claim 1, wherein the portion of the external surface to which the thermoplastic overlay is bonded extends longitudinally along the composite pipe away from the pipe end.

24. The composite pipe of claim 23, wherein the composite overlay extends longitudinally beyond the pipe end.

25. The composite pipe to claim 23 comprising an end-fitting, the end-fitting comprising a metal vault disposed around the composite overlay, the metal vault comprising (i) means to lock the metal vault into mating engagement with the composite overlay and (ii) means for sealingly attaching a connector into to the pipe end.

26. A unbonded, flexible pipe, comprising the composite pipe according to claim 1 with one or more armour layers disposed around the external surface of the composite pipe and/or within the composite pipe.

27. A method of using the composite pipe of claim 1, comprising transporting hydrocarbon fluid, hydrogen fluid or carbon dioxide fluid or a mixture thereof.

28. A method of manufacturing a composite pipe which extends longitudinally and has an internal surface and an external surface, a composite overlay being disposed around and bonded to a portion of the external surface, the method comprising:
a. providing a composite pipe;
b. winding a first layer of composite tape around and bonding it to the portion of the external surface; and
c. winding one or more additional layers of composite tape around and bonding each such additional layer to the immediately preceding layer of composite tape until a desired overlay thickness has been achieved;
wherein the composite pipe and the composite tape comprise a composite material having a thermoplastic polymer matrix and fibres embedded in the thermoplastic polymer matrix, wherein the fibres embedded in the thermoplastic polymer matrix of the composite pipe comprise continuous fibres, and wherein the fibres embedded in the thermoplastic polymer matrix of the composite tape comprise short fibres, which are fibres having a length from 0.05 mm to 10 mm.

29. The method of claim 28, wherein after a. and before b.:
a1. the portion of the external surface is machined to reduce its external diameter.
